(19) United States
(12) Patent Application Publication
(10) Pub. No.: US 2004/0230943 A1
(43) Pub. Date: Nov. 18, 2004

(54) System and method for managing information technology resources

(75) Inventors: M. Homayoun Pourheidari, Mountain View, CA (US); Nicolas Catania, Palo Alto, CA (US); Bryan P. Murray, Duvall, WA (US); Guillaume N. Vambenepe, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 10/438,662

(22) Filed: May 14, 2003

(51) Int. Cl. G06F 9/44

(52) U.S. Cl. 717/101; 717/120

(57) ABSTRACT

A system for managing an information technology (IT) resource comprises a computer processor and a managed object executable on the computer processor. The managed object is associated with the resource and includes information regarding at least one interface configured to allow a manager to monitor the resource. The manager can discover an interface description document. The interface description exposes selected management features for the resource to the manager. Different management features can be exposed to different managers based on the manager's access privileges. Managers with appropriate authority can access other management features for a particular resource through one or more extended interfaces.

### RELATED APPLICATIONS

The disclosed system and operating method are related to subject matter disclosed in the following co-pending patent applications that are incorporated by reference herein in their entirety: (1) U.S. patent application Ser. No. ______, entitled “System and Method for Managing Conversations” (Attorney Docket No. 2003009896-1); and (2) U.S. patent application Ser. No. ______, entitled “System and Method for Managing Web Services”, (Attorney Docket No. 2003009897-1).

### COMPUTER PROGRAM LISTING APPENDIX

This specification includes Appendix A (consisting of one text file) on CD-ROM, which contains interface description documents that can be used with some embodiments of the invention. The files on the compact discs are as follows:

1. Conversation Interfaces Description.wsdl (12 KB created May 14, 2003);

2. Event Interfaces Description.wsdl (10 KB created May 14, 2003);

3. Managed Object Interfaces Description.wsdl (22 KB created May 14, 2003);

4. Service Interfaces Description.wsdl (18 KB created May 14, 2003); and

5. WSEE Interfaces Description.wsdl (6 KB created May 14, 2003). Appendix A is incorporated herein by reference.

### BACKGROUND

Today, information technology (IT) resources are managed using a variety of incompatible and often proprietary interfaces and protocols. Requirements for management information regarding the resources need to be specifically programmed to address new resources and in many cases the specific programming is not updated as new versions of the IT resources become available.

The problem of managing disparate IT resources is becoming more acute as systems are increasingly developed using IT resources that are deployed in remote locations and accessed via information networks, such as the Internet. Generally, the resources to be managed are not readily identifiable when the resources are highly distributed and independent of one another. Further, it is difficult to obtain information regarding properties and attributes of the resources, and protocols for exchanging management information with the resources. A further difficulty lies in determining the relationships among the resources used in a system to pinpoint operational problems when one or more of the resources do not respond as expected.

The term Web services, also referred to herein as “services”, describes an approach to distributed computing in which interactions are carried out through the exchange of extensible Markup Language (XML) messages. Web services can perform any task that can be described and contained within one or more modules of code. Essentially any transaction or bit of business logic can become a Web service if it can be accessed and used by another system over the Internet.

A Web service is a software system identified by a Universal Resource Identifier (URI) whose public interfaces and bindings are typically defined and described in an XML document. The description can be discovered by other software systems. These systems may then interact with the Web service in a manner prescribed by its definition, using XML based messages conveyed by Internet protocols.

The Web services architecture is based upon the interactions between three primary roles: service provider, service registry, and service requestor. These roles interact using publish, find and bind operations. The service provider is the entity that provides access to the Web service and publishes the service description in a service registry. The service requestor finds the service description in a service registry and can use the information in the description to bind to a service.

Web services typically send XML messages formatted in accordance with the Simple Object Access Protocol (SOAP) specification. The SOAP specification is a universally agreed-upon protocol that can use XML and HTTP together to invoke functions exposed in Web services.

The XML messages are described using the Web Services Description Language (WSDL) specification, which, along with the Universal Description Discovery and Integration (UDDI) registry, provides a definition of the interface to a Web service and identifies service providers in a network. The WSDL specification is an XML-based language used to define Web services and describe how to access them. An application trying to use a particular Web Service can often use WSDL to find the location of the Web service, the function calls available, and the format that must be followed to access the Web service. Therefore, the client first obtains a copy of the WSDL file from the server and then uses the information in this file to format a SOAP request.

The UDDI registry supports Web services by providing a place for a company to register its business and the Web services that it offers. Users that need a Web service can use this registry to, find a business that provides the service.

### SUMMARY

In one embodiment, a system for managing an information technology (IT) resource comprises a computer processor and a managed object executable on the computer processor. The managed object is associated with the resource and includes information regarding at least one interface configured to allow a manager to monitor the resource.

In another embodiment, a computer program product comprises an interface; an extended interface; and a managed object associated with the interface. The interface is configured to include information for managing an IT resource, including information indicating relationships between the managed object and other managed objects.

In yet another embodiment, a method for managing an IT resource comprises creating a managed object representing the resource, wherein the managed object includes a management interface; exposing selected management capabilities for the resource via a description of the management interface; and allowing a manager to subscribe with the managed object to receive notification of selected events regarding the resource.

Various other features of embodiments of the invention will be more fully understood upon consideration of the detailed description below, taken together with the accompanying figures.

### BRIEF DESCRIPTION OF THE FIGURES

FIG. 1 is a diagram of components included in an embodiment of an information technology (IT) resource management system.

FIG. 2 is a diagram showing further detail of an embodiment of managed object interfaces of FIG. 1.

FIG. 3A is a diagram showing further detail of the resource management system of FIG. 1.

FIG. 3B is a diagram showing components in an embodiment of interface descriptions for a managed object interface collection.

FIG. 4 shows a diagram of components included in an embodiment of an online shopping service system that can utilize the IT resource management system of FIG. 1.

FIG. 5 shows a block diagram of components in online ordering system of FIG. 2 configured with managed objects and corresponding management interfaces.

FIG. 6 shows a diagram of the topology of the managed objects of FIGS. 4 and 5.

FIG. 7 shows a diagram of the relationships between the managed objects of the online shopping service system of FIGS. 4 and 5.

FIG. 8 shows managed object topological diagram of FIG. 6 with managed objects configured with dotted boxes to indicate propagation of a status value associated with a failure in one of the managed objects.

### DETAILED DESCRIPTION OF THE FIGURES

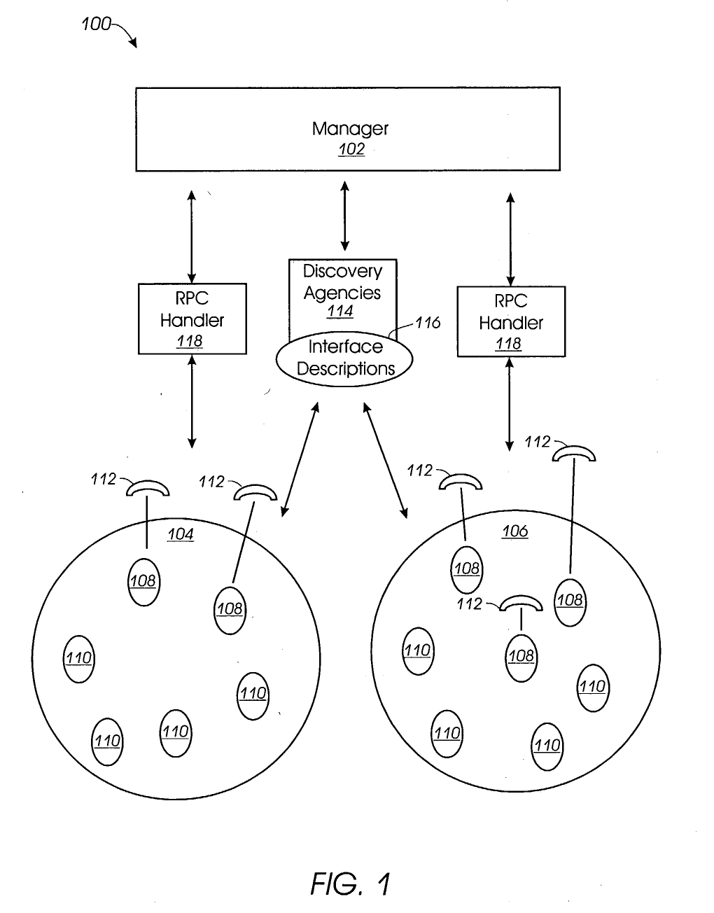

Referring to FIG. 1, an embodiment of a management system 100 that allows manager 102 to monitor and control information technology (IT) resources in one or more domains 104, 106 is shown. The resources can be any type of software, hardware, and/or firmware that is configured to interface with manager 102. Resources that are configured to interface with manager 102 are represented by managed objects 108. Resources that are not configured to interface with manager 102 are represented by unmanaged objects 110.

Managed object interfaces 112 allow manager 102 to access information to monitor, audit, and control various aspects of resources represented by managed objects 108, and to register to receive event notifications. Manager 102 can also use information in managed object interfaces 112 to determine management attributes and relationships among related managed objects 108.

Managed objects 108 interface with the underlying resources to gather information to populate data fields in managed object interfaces 112 that are available to manager 102. Further, managed objects 108 receive information and control parameters from manager 102 via managed objects interfaces 112.

Various implementations of managed object interfaces 112 can hide selected management capabilities from managers 102 that are not authorized to access the selected management capabilities. Each managed object 108 can also utilize one or more additional extended interfaces that expose relevant information to manager 102. The extended interfaces can be implemented as needed based on the type of resource to be managed.

In some embodiments, manager 102 and managed objects 108 can communicate with one or more discovery agencies 114 to access interface descriptions 116 for managed object interfaces 112. Interface descriptions 116 can be configured to expose some or all of the management features that are available through a particular managed object interface 112 to manager 102.

Interface descriptions 116 provide a common framework for exposing management services for all managed objects 108 regardless of the resources they represent. Managed object interfaces 112 can be implemented in various languages and formats. Interface descriptions 116 define management features available through managed object interfaces 112 in a common format that can be used by other managed objects 108 and manager 102. In some embodiments, interface descriptions 116 define managed object interfaces 112 in Web Services Description Language (WSDL), and messages between manager 102 and managed objects 108 can be exchanged via the Simple Object Access Protocol (SOAP) protocol. Other suitable formats and protocols can be utilized. Further, manager 102 can discover interface descriptions 116 for managed object interfaces 112 via any suitable discovery agency 114, such as UDDI, or other suitable method.

Managed objects 108 can themselves be utilized as Web services by manager 102. Web services can be document-oriented endpoints or method-oriented endpoints. The XML messages exchanged with a document-oriented Web service contain an XML document, and all message semantics are application-defined. An example of document- oriented Web services is discovery agencies 114, which provide interface descriptions 116 to manager 102. With method-oriented Web services, such as managed objects 108, remote procedure call (RPC) handler 118 can be implemented to transmit and receive messages corresponding to a RPC. Message(s) pass inbound from manager 102 to one or more of managed objects 108 and contain a method identifier and any input parameters for the method. The information in the message can be used to map to a method call in the appropriate native programming language for the underlying resource, and to execute the method with the supplied input parameters. After the method executes, another message passes outbound from managed object(s) 108 to manager 102 and contains the method identifier, the result of executing the method, and any output parameters (or exception information in the case of an error).

RPC handler 118 alleviates the need for a developer to write, transmit, interpret, correlate messages by hand, and then map them to and from various native programmatic types used by the underlying resources. A common XML messaging protocol for RPCs is the Simple Object Access Protocol. In some embodiments, a Java application program interface (API) for XML-based remote procedure calls (referred to as JAX-RPC) can be used to implement RPC handler 118 and call SOAP-based Web services described by the Web Services Description Language (WSDL). Other suitable common remote procedure call facilities and protocols can be utilized to implement RPC handler 118 in addition to, or instead of, JAX-RPC and SOAP. RPC handlers 118 can be deployed as part of managed objects 108, or provided independently on a platform that can access the corresponding managed objects 108.

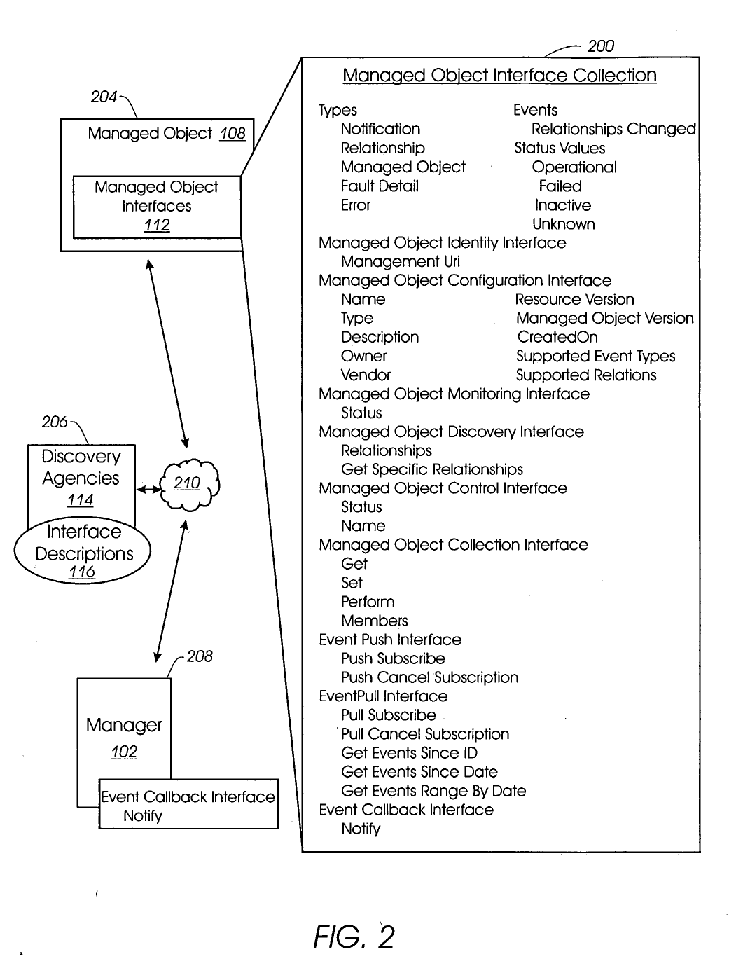

Referring now to FIG. 2, in some embodiments, management capabilities provided via managed object interfaces 112 include attributes that represent information about managed objects 108; operations to support the management of managed objects 108; and events representing exceptions and state changes that can be reported by managed objects 108 to manager 102. Managed object interfaces 112 can be implemented within managed objects 108, such as shown for managed object 108 in FIG. 2, or in a layer external to managed object 108 as shown in FIG. 1. Similarly, managed objects 108 can be implemented internally or externally to the resources they represent.

In some embodiments, each collection of managed object interfaces 112 supports various categories of management capabilities such as monitoring, discovery, control, performance, configuration, and security. Additional or fewer categories can be utilized. Further, other interfaces that support additional or different management capabilities can be utilized, in addition to, or instead of, managed object interfaces 112.

Several types of components can be used in managed object interfaces 112. The embodiment of Managed Object Interface Collection 200 shown. in FIG. 2 includes Notification, Relationship, Managed Object, Fault Detail, and Error types that can be implemented in managed object interfaces 112. Attributes in Managed Object Interface Collection 116 can support types of access by other objects, such as read and read/write. When interface descriptions 116 are implemented in WSDL, managed object interfaces 112, can be mapped to ports, and access policies can be mapped to operations on attributes, as further described herein.

Notification type can be used for event notifications that can be sent to manager 102. Relationship type can describe a relationship between two or more managed objects 108. Managed Object can be a simple type based on the XML schema any URI type and point to interface descriptions 116 for a particular managed object 108. An element of FaultDetail type can be added to the fault detail element of all SOAP faults returned by managed object interfaces 112, and other interfaces associated with particular types of managed objects 108. Error type can describe an error. The Fault Detail element type can include one or more of the Error type elements to offer more specific information about the error.

The embodiment of Managed Object Interface Collection 200 shown also includes Status values and Events. For example, the type Relationships Changed Event can indicate an update to relationships in managed object 108. Relationships Changed Event can occur when a new relationship is added or when a previous relationship has been removed. Manager 102 can get an updated list of relationships by using the Relationships attribute in the Managed Object Discovery Interface as described herein.

With regard to Status values included in the embodiment of Managed Object Interface Collection 200 shown in FIG. 2, Operational status can indicate the underlying resource is operational and ready to process incoming messages. Failed status can indicate managed object 108 has detected a problem and the underlying resource is unable to process incoming messages. Inactive status can indicate underlying resource has terminated normally. Unknown status can indicate the state of the underlying resource is unknown.

Interfaces shown in the embodiment of Managed Object Interface Collection 200 of FIG. 2 include Managed Object Identity Interface, Managed Object Configuration Interface, Managed Object Monitoring Interface, Managed Object Discovery Interface, Managed Object Control Interface, Managed Object Collection Interface, Event Push Interface, and Event Pull Interface.

Event Callback Interface can be implemented by a subscriber, such as manager 102, to receive push events.

Managed objects 108 can implement Management Object Identity Interface, which includes attribute Management URI. Management URI can return the URI for interface descriptions 116 of Managed Object Interfaces 112.

Managed Object Configuration Interface can include components such as attributes with information regarding the configuration of associated managed object 108, for example, Name, Type, Description, Owner, Vendor, Resource Version, Managed Object Version, Created On, Supported Event Types, and Supported Relations.

Name can represent an attribute that returns the name of managed object 108. Name can be a read-write attribute, and the write portion can be handled in another interface, such as the Managed Object Control Interface, as further described herein.

Type can represent attribute that returns the type of managed object 108. The types that are available will depend on the domain and the resources being managed. For example, to manage Web services, types such as Web service, Web service execution environment, and Conversation can be utilized in some embodiments.

Description can represent an attribute that returns a description of managed object 108. Manager 102 can present the description when a user requests more information regarding a particular managed object 108. The information can be distinct from interface descriptions 116.

Owner can represent an attribute that returns the owner of managed object 108. The owner can be the entity that deployed the resources underlying managed object 108. For instance, if a company has developed and deployed a resource that can be hosted on a third-party system, the company can still own the associated managed object 108. In addition, if a company has purchased the rights to use and deploy a resource locally, the company can own the resource.

Vendor can represent an attribute that returns the vendor originating managed object 108.

Resource Version can represent an attribute that returns the version of the underlying resource.

Managed Object Version can represent an attribute that returns the version of managed object 108.

Created On can represent an attribute that returns the date and time managed object 108 was created.

Supported Event Types can represent an attribute that returns a list of the event types supported by managed object 108. Any of these events may be subscribed to in either a push or pull mode by calling the appropriate subscribe operation as further described herein.

Supported Relations can represent an attribute that returns a list of the relations supported by managed object 108. Any of the relations in the list may be used in relationships managed object 108 has with other managed objects.

For example, to manage Web services, managed object 108 can support relations such as Contains, Contained In, Depends On, Depended Upon, and Corresponds To. A containing managed object can use the Contains relation to indicate its relationship with a managed object it contains. A managed object 108 contained by another managed object 108 can use the Contained In relation to indicate its relationship with the managed object 108 that contains it. A managed object 108 that depends on another managed object 108 can use the Depends On relation to indicate its relation with the managed object 108 on which it depends. A managed object 108 that can be depended upon by another managed object 108 can use the Depended Upon relation to indicate its relationship with the dependent objects. A managed object 108 can use the Corresponds To relation to indicate a peer relationship with another managed object 108. Other suitable relations can be utilized. Manager 102 can use the Get Relationships operation to discover the managed objects 108 that are linked to a certain managed object 108 by relationships.

Managed Object Monitoring Interface includes a Status attribute, which can represent an attribute that returns the status of managed object 108. The status can be represented as a URI for a document that includes information regarding the status of the underlying resources. Managed Object Interface Collection 200 defines basic status values, which are supported by all managed objects 108. Other interfaces may define other status values that may be returned by the Status attribute. The read portion of the Status attribute can be in the Managed Object Monitoring Interface, and the write portion of the Status attribute can be in the Managed Object Control Interface. Handling the read and write portions of the Status attribute in different interfaces allows the owner of managed object 108 to offer read-only access to the status to one manager 102, and read- write access to the status to other managers 102.

Managed Object Discovery Interface can include a Relationships attribute and a Get Specific Relationships operation. Relationships can be an attribute that returns a list of relationships that are currently active for managed object 108. The list of relationships can be dynamic and can change as the underlying resource interacts with other resources. Get Specific Relationships (relation) can be an operation that returns a list of URIs of relationships having a specific relation with another managed object 108. This operation typically returns a subset of the list returned by the Relationships attribute.

Managed Object Control Interface can be used to modify the state of managed object 108. Access to Managed Object Control Interface can be controlled via interface descriptions 116 to allow only managers 102 with acceptable privileges use Managed Object Control Interface. The embodiment of Managed Object Control Interface shown includes Status and Name attributes, which are similar to the Status and Name attributes in the Managed Object Configuration Interface. Managers 102 with access to Managed Object Control Interface can set the values for the Status and Name attributes, however.

In the embodiment shown, Managed Object Collection Interface includes Get, Set, and Perform operations, and Members attribute.

Get (select, interface, name) can represent an operation used to query the value of an attribute from members of a collection of managed objects 108. Set (select, interface, name, XML value) can represent an operation used to modify the value of an attribute on members of a collection of managed objects 108. Perform (select, interface, name, XML arguments) can represent an operation used to invoke an operation on members of a collection of managed objects. The management interface and the name of the attribute can be specified by the interface and name arguments. The select argument can be an XPATH expression that identifies a subset of members of the collection. XPath is a non-XML language used to identify particular parts of XML documents. The return value can be a list of structures that contain either the value of the specified attribute or fault information that resulted from the query on a particular managed object 108. Other suitable languages can be used in addition to, or instead of, Xpath and XML.

Members can represent an attribute that returns a list of the members of the collection.

The Event Push Interface includes Push Subscribe and Push Cancel Subscription operations. The operation Push Subscribe (EventTypes, CallbackUrl, ExpirationTime) allows manager 102 to register to receive a notification when any of a list of event types occur. The types of events available for interface collections 116, 200 can be determined by manager 102 via the Supported Event Types attribute in the Managed Object Configuration Interface. The return value from the Push Subscribe operation can be a subscription ID. Manager 102 can pass the subscription ID to the Push Cancel Subscription operation to stop receiving notifications for the specified event types. The subscription can expire automatically after the expiration of a pre-specified time period. Manager 102 can invoke the Push Subscribe operation again to continue to receive event notifications.

Pull Subscribe (EventTypes, ExpirationTime) can represent an operation that allows manager 102 to subscribe to receive notifications of specified event types. Managed object 108 can cache events of the types specified for later retrieval using one of the following operations: GetEventsSinceld, GetEventsSinceDate, and GetEventsRangeByDate. The types of events available for Managed Object Interface Collection 200 can be determined by manager 102 via the Supported Event Types attribute in the Managed Object Configuration Interface. The return value from the Pull Subscribe operation can be a subscription ID. Manager 102 can pass the subscription ID to the Pull Cancel Subscription operation to stop receiving notifications for the specified event types. The subscription can expire automatically after a prespecified period of time expires, at which time the specified event types will no longer be cached for that subscription. In order to continue to receive events of this type, manager 102 can re- subscribe for the desired event types.

Managed object 108 can save events for all types specified in all subscriptions. If no subscription has specified some event type, all events of that type may be discarded. When a subscription is cancelled or expires, the queued event types may be discarded if no other subscriptions have expressed interest in the same event types. Each implementation can specify the time period to determine when subscriptions expire and how long events are saved before they are discarded.

Pull Cancel Subscription (SubscriptionId) can be an operation that allows manager 102 to indicate the termination of interest in event types from previously registered subscriptions. The subscription ID passed to this operation can be the ID returned from a previous call to Pull Subscribe.

Get Events Since Id (Subscriptionld, Eventld) can represent an operation that retrieves all events that have occurred since the event specified by the Eventld. Only the events of the type specified by the previous subscription will be returned.

Get Events Since Date (Subscriptionld, Date) can represent an operation that retrieves all events that have occurred since the specified date and time. Only the events of the type specified by the previous subscription will be returned.

Get Events Range By Date (Subscriptionld, StartDate, EndDate) can represent an operation that retrieves all events that occurred in the specified date range. Only the events of the type specified by the previous subscription will be returned. In order to avoid missing any events, the date range can be inclusive of the endpoints.

Event Callback Interface can be listed in Managed Object Interface Collection 200 because it applies to all managed objects 108. Event Callback Interface can be defined in a separate events namespace and implemented by a subscriber to a push event, such as manager 102.

Event Callback Interface can include Notify (notifications) operation, which can be provided by a subscriber to push events. When managed object 108 undergoes a state change that results in the occurrence of one or more events to which a subscriber has subscribed, managed object 108 invokes the Notify operation with a corresponding list of notifications. A subscriber can implement Event Callback Interface in order to receive notifications.

The preceding types, operations, and attributes are examples of features that can be included in Managed Object Interface Collection 200. Other features can be implemented for Managed Object Interface Collection 200 in addition to, or instead of, the preceding features. Further, the names for the interfaces, attributes, events, operations and other interface features disclosed herein are provided for purposes of illustration only. The same names can be used to represent different features, and other names can be implemented to represent features disclosed herein.

### Extending Management Capabilities for Managed Objects

In some embodiments, interface descriptions 116 can define schemas for messages and corresponding WSDL parts; port types; marker attributes; and namespaces. Port types describe a list of potential management capabilities for manager 102. Ports that implement some or all of the port types defined in interface descriptions 116 allow managed objects 108 to expose their management capabilities and provide manager 102 with instructions for using the management capabilities. Managed objects 108 can expose different portions of the management interfaces to different managers 102. An example of WSDL interface descriptions 116 suitable for use with some embodiments of Managed Object Interface Collection 200 described herein are provided in the Appendix filed with this disclosure.

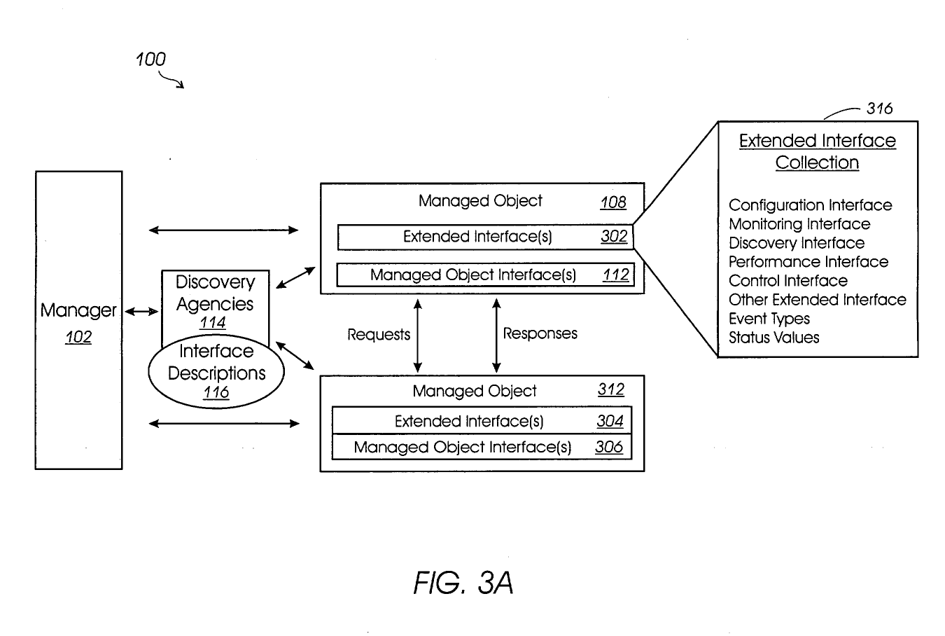

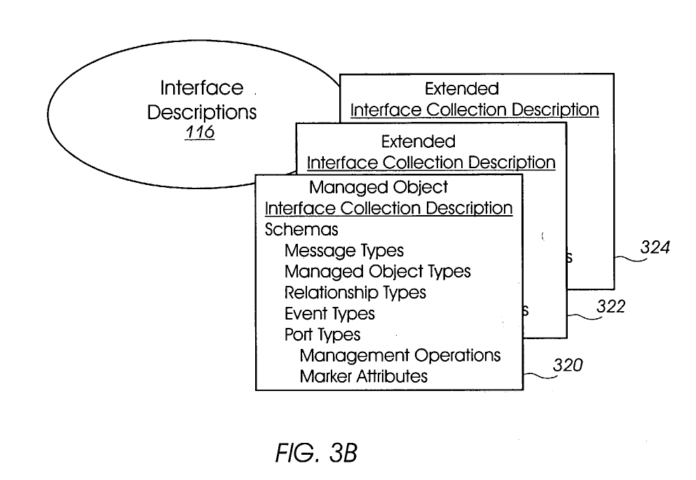

Referring to FIGS. 3A and 3B, another embodiment of management system 100 is shown with extended interfaces 302, 304 that can be implemented to extend managed object interfaces 112, 306 to manage additional aspects of respective managed objects 108, 312. In some embodiments, marker attributes for new management port types can be implemented in corresponding interface descriptions 116 to expose additional management aspects of managed objects 108, 312. The following discussion pertains to extended interfaces 302, 304, even though reference is made primarily to extended interfaces 302 as shown in FIG. 3A to simplify notation.

Port types can describe a list of potential management capabilities for Manager 102. By making ports available that implement some or all of the port types defined in corresponding interface descriptions 116, managed objects 108 can expose their management capabilities and provide manager 102 with instructions to use the management capabilities.

Managed object 108 is not required to expose the same managed object interfaces 112 or extended interfaces 302 to all callers. It is anticipated that many managed objects 108 will expose different features in managed object interfaces 112 and extended interfaces 302 to different requesters, such as:

limiting anonymous managers 102 to only query basic information;

allowing recognized managers 102 to also query performance information; and

allowing trusted managers 102 (e.g., administrators) access to all features in managed object interfaces 112 and extended interfaces 302.

Managed objects 108 can implement selected management port types. Management port types can be derived from managed object interfaces 112 as follows:

a) A specific namespace corresponds to each Managed Object Interface Collection 200 (FIG. 2) and to each Extended Interface Collection 316 that extends the management features for managed object 108 beyond the features available in managed object interfaces 112.

b) Inside each Interface Collection, all attributes, operations and notifications are assigned an interface category.

c) For each Interface Collection:

i) for each attribute with read (R) access, a get operation can be created that takes an empty input message and returns the attribute;

ii) for each attribute with write (W) access, a set operation can be created that takes the attribute and returns an empty input message;

iii) for each operation in the Interface Collection, a WSDL operation can be created with the same signature.

In some embodiments, a marker attribute can be added to the port types to indicate to manager 102 that the port types are management port types. Note that extended interface collection 316 can use none, some, or all of the interface categories shown, as well as other categories of interfaces. Additionally, various status values and event types can be defined in extended interface collection 316 that pertain to the management of resources underlying managed object 108.

To extend resource management system 100 by defining a new relation, a URI to represent the new relation and an operation to follow the relation can be created in some embodiments. The relation attribute to the operation can be defined to indicate that the operation corresponds to the newly defined relationship by setting the value of the attribute to the URI representing the relation. For example, suppose a company defines a new relation called “like” and assigns to it the URI “http://mycompany.com/relations/like”; the following segment describes how the Relation attribute can be used to express the fact that the “GetServicesLike” operation corresponds to the following “like” relation:

```
<myns:portType name=“myPortType”>
  <operation name=“getServicesILike”
      wsmf:relation=“http://mycompany.com/relations/like”>
  (. . .)
  </operation>
</myns:portType>
```

When an operation is marked with the Relation attribute, then the operation typically returns a list of managed objects 108. The list of managed objects 108 can be the same as returned by the GetRelationships operation supported by managed object interface 112 with the exception of managed objects 108 that do not correspond to the relation designated by the Relation attribute.

### Discovery Mechanisms

Management system 100 can utilize a discovery mechanism to discover managed object interfaces 112 of a managed object 108. The discovery mechanism typically does not retrieve management interface information for managed object 108 from a central point. Using interface descriptions 116 formatted in WSDL as an example, the Managed Object Identity Interface of managed object interfaces 112 can return a URI or other suitable identifier that points to the location of a WSDL document. The WSDL document can be the root of a tree that defines all management interfaces (intended for the recipient of the pointer), where nodes in the tree may be joined via elements included in the WSDL document; WSDL include statements; WSDL import statements; and/or WS- Inspection statements. Once the complete interface description 116 has been assembled, the resulting set of elements can include one or more services that contain one or more ports implementing at least one port type.

Referring again to FIG. 2, components included in manager 102, managed object 108, and discovery agencies 114 are typically implemented in computer processing systems 204 through 208, respectively.

Processing systems 204 through 208 can be any suitable computer-processing device that includes memory for storing and executing logic instructions, and is capable of interfacing with other processing systems. In some embodiments, processing systems 204 through 208 can also communicate with other external components via network 210. Various input/output devices, such as keyboard and mouse (not shown), can be included to allow a user to interact with components internal and external to processing systems 204 through 208.

Additionally, processing systems 204 through 208 can be embodied in any suitable computing device, and so include personal data assistants (PDAs), telephones with display areas, network appliances, desktops, laptops, X-window terminals, or other such computing devices. Processing systems 204 through 208 and corresponding logic instructions can be implemented using any suitable combination of hardware, software, and/or firmware, such as microprocessors, Field Programmable Gate Arrays (FPGAs), Application Specific Integrated Circuit (ASICs), or other suitable devices.

Logic instructions executed by processing systems 204 through 208 can be stored on a computer readable medium, or accessed by processing systems 204 through 208 in the form of electronic signals. Processing systems 204 through 208 can be configured to interface with each other, and to connect to external network 210 via suitable communication links such as any one or combination of Ti, ISDN, cable line, a wireless connection through a cellular or satellite network, or a local data transport system such as Ethernet or token ring over a local area network.

The Hypertext Transfer Protocol/Secure (HTTPS) is a suitable communication protocol when integrity and/or confidentiality of the SOAP messages is required. When end-to-end security of the SOAP payload is required, WS-Security or other communication protocols may be used. Manager 102 can also authenticate itself to managed objects 108 and vice-versa. Mutual authentication features of HTTPS or other suitable authentication methods can be used.

### Managing Web Services

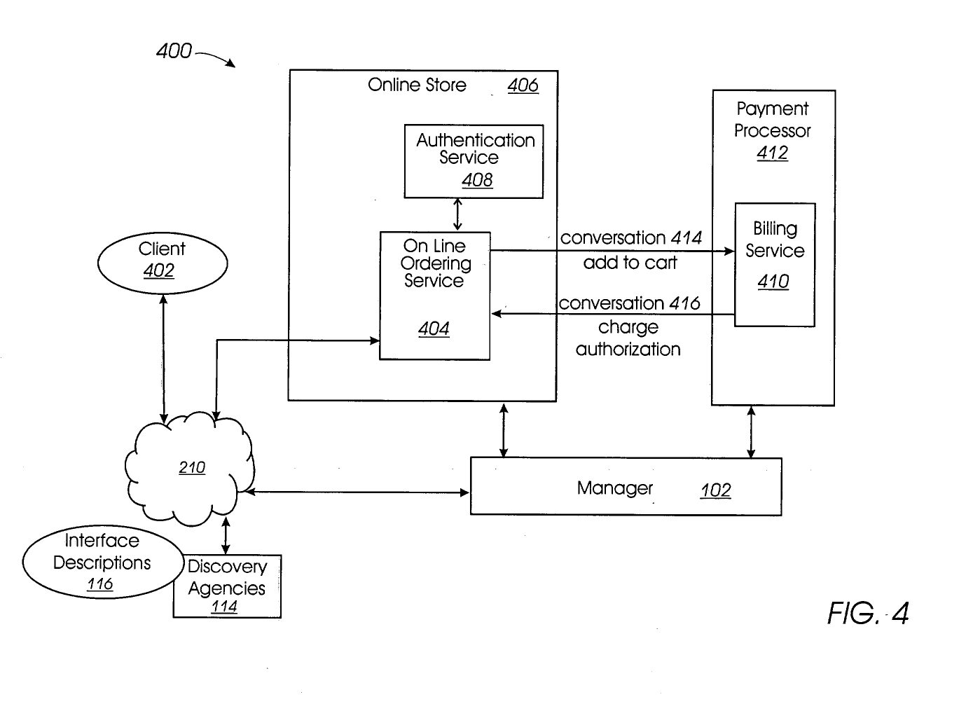

Embodiments of management system 100 (FIG. 1 ) provide a framework for managing IT resources in any domain. For example, management system 100 can be applied to the specific domain of managing Web services for online shopping service system 400, as shown in FIGS. 4 through 8.

A computer system associated with a purchaser, referred to as client 402, accesses online ordering service 404 at online store 406 via a suitable interface through network 210. Online ordering service 404 accesses authentication service 408 and billing service 410.

Billing service 410 can be implemented by a third party in payment processor 412. Information regarding transactions, such as credit card charge authorizations, is exchanged via conversations 414, 416 between online ordering service 404 and billing service 410. Authentication service 408 authenticates user identification information and enables users to access information previously supplied to make purchases. Billing service 410 allows the purchaser to pay with a credit card or checking account for one or more items. Payment processor 412 can send the payment to the vendor's account.

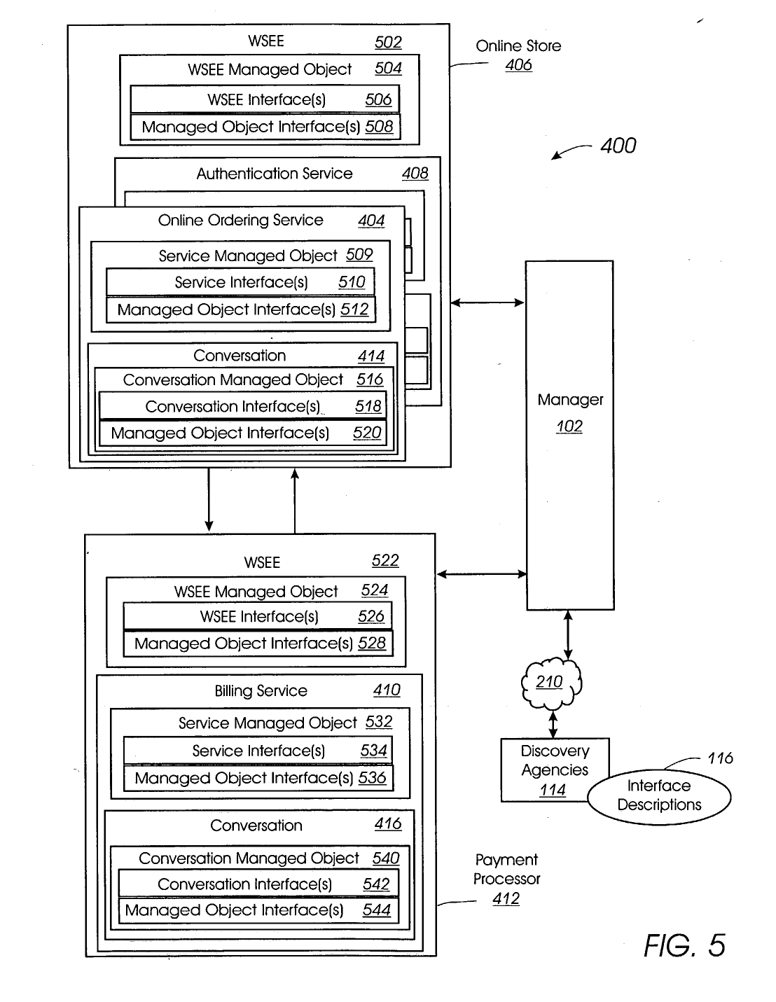

In the embodiment of online shopping service system 400 shown in FIGS. 4 and 5, a set of managed objects for managing Web services can include one or more service managed objects 509, 532; one or more Web service execution environments (WSEE) managed objects 504, 524; and one or more conversation managed objects 516, 540, for example. Interface collections (not shown) can be defined for one or more interfaces in each managed object 504, 509, 516, 524, 532, 540 to describe management capabilities for the corresponding resources. Furthermore, a model, or schema, can be defined to support the relationships and interactions between the managed objects. Attributes can be defined that support specific information about the managed objects along with operations that support the management capabilities of the managed objects. The management features can be exposed through interface descriptions that define some or all of the management interfaces. Manager 102 can be configured to interface with one or more of managed objects.

Examples of service and Web Service Execution Environment (WSEE) interface collections that can be used in some embodiments are described in the disclosure entitled “System and Method for Managing Web Services”, U.S. patent application Ser. No. ______ (Attorney Docket No. 2003009897-1). An example of a conversation interface collection that can be used in some embodiments is described in the disclosure entitled “System and Method for Managing Conversations”, U.S. Pat. application Ser. No. ______ (Attorney Docket No. 2003009896-1).

FIG. 5 shows online store 406 and payment processor 412 configured with management interfaces. Online ordering service 404 and authentication service 408 operate in WSEE 502. WSEE managed object 504 can be configured with WSEE interfaces 506 and managed object interfaces 508. Online ordering service 404 contains conversation 414. Service managed object 509 can be configured with service interfaces 510 and managed object interfaces 512. A similar set of managed objects and management interfaces can be configured for authentication service 408. Conversation managed object 516 can be configured with conversation interfaces 518 and managed object interfaces 520.

With regard to payment processor 412, billing service 410 operates in WSEE 522. WSEE managed object 524 can be configured with WSEE interfaces 526 and managed object interfaces 528. Billing service managed object 532 includes conversation 416, and can be configured with service interfaces 534 and managed object interfaces 536. Conversation managed object 540 can be configured with conversation interfaces 542 and managed object interfaces 544. WSEE interfaces 506, 526, service interfaces 510, 534, and conversation interfaces 518, 542 are examples of extended interfaces for managed object interfaces 508, 512, 520, 528, 536, and 544, respectively.

Manager 102 can discover interface descriptions 116 to learn about the management capabilities available for the various managed objects in online shopping service system 400. In some embodiments, manager 102 includes a configuration file with a list of URIs of the locations of interface descriptions 116 for the management interfaces associated with a particular managed object. Manager 102 can alternatively discover interface descriptions 116 with a UDDI lookup or other suitable discovery method. Once manager 102 discovers a managed object, manager 102 can invoke the Get Relationships method in the corresponding managed object interfaces to discover other related managed objects. Manager 102 can invoke the Get Container method in the service interfaces 510, 534 to retrieve WSEE interfaces 506, 526 and managed object interfaces 508, 528.

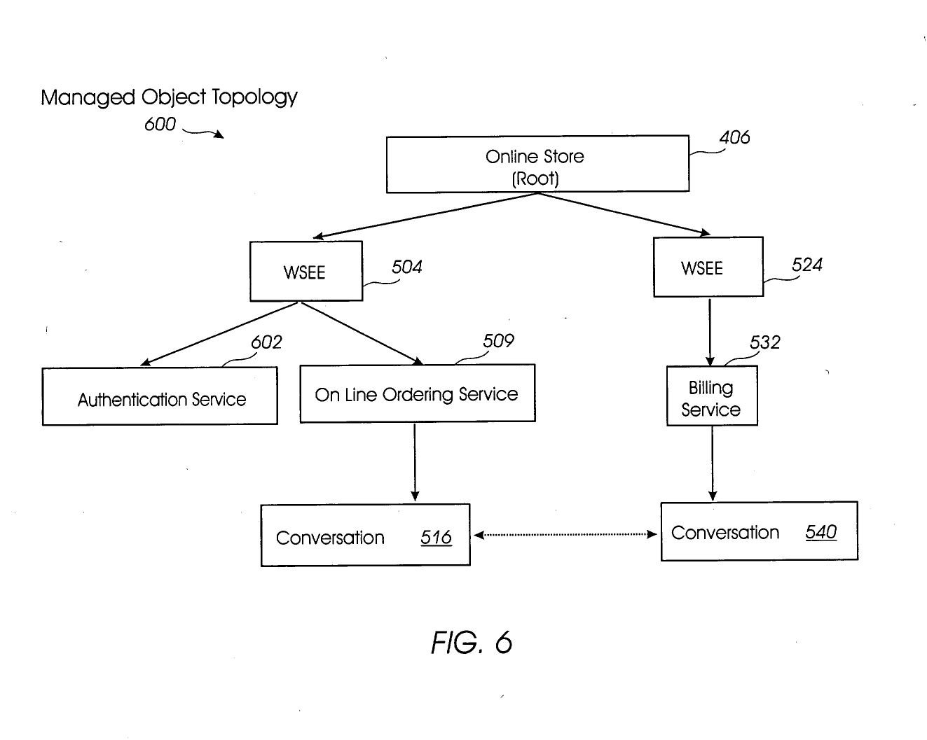

FIG. 6 shows a topological diagram 600 of the managed objects of FIG. 5, as developed by manager 102. Online store 406 can be a root object with respect to other components in online shopping service 400 (FIGS. 4 and 5 ). Managed objects included on one branch of online store 406 are shown as WSEE managed object 504, authentication service managed object 602, online ordering service managed object 509, and conversation managed object 516. The managed objects on the other branch of online store 406 include WSEE managed object 524, billing service managed object 532, and conversation managed object 540.

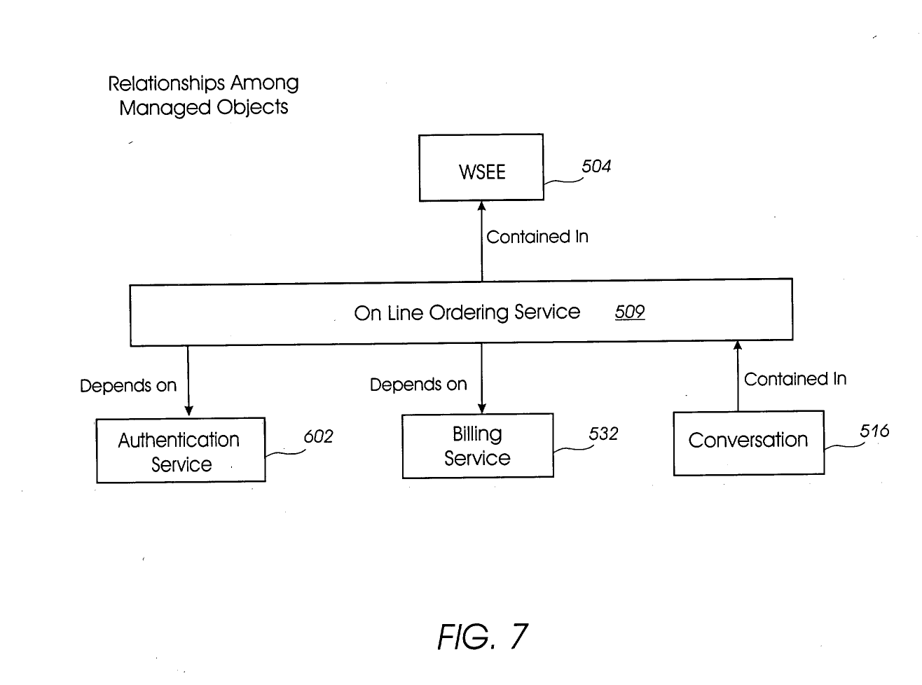

FIG. 7 shows a diagram of the relationships between managed objects in online store 406 from the viewpoint of online ordering service 404. As shown, online ordering service managed object 509 can be contained in WSEE managed object 504. Online ordering service managed object 509 depends on authentication service managed object 602 and billing service managed object 532. Conversation managed object 516 can be contained in online ordering service managed object 509.

Referring again to FIG. 5, in some embodiments, manager 102 invokes the Push Subscribe and/or Pull Subscribe in one or more of managed object interfaces 508, 512, 520, 528, 536, 544 to receive notifications from corresponding managed objects 504, 509, 516, 524, 532, 540, respectively. As an example of the notification process, assume manager 102 has subscribed to receive notification of events from conversation managed object 516. When an event, such as no response from conversation 416, occurs, manager 102 receives a participant failure notification from conversation managed object 516 via associated managed object interfaces 520. The event can indicate a level of severity, such as critical, for example. When manager 102 receives the notification, a status propagation rule in manager 102 can change the status of other managed objects that are affected by the event.

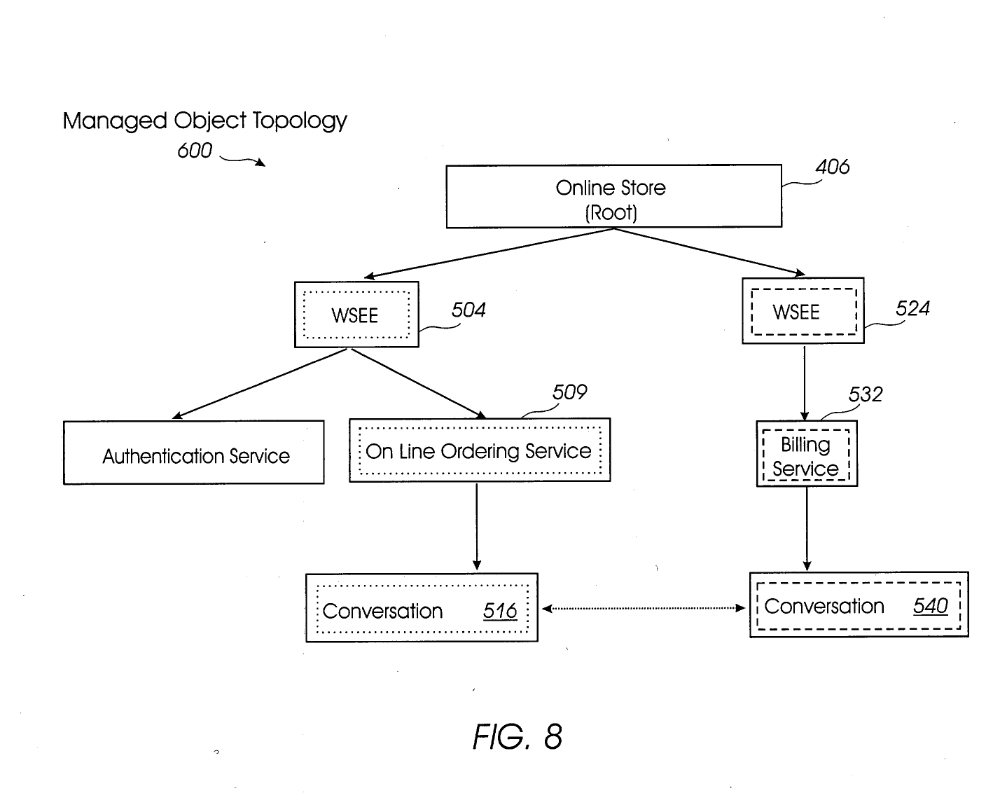

To illustrate propagation of the error status among related managed objects, FIG. 8 shows managed object topological diagram 600 of FIG. 6 with WSEE managed object 504, online ordering service managed object 509, and conversation managed object 516 configured with dotted boxes to indicate a status value associated with a failure. WSEE managed object 524, billing service managed object 532, and conversation managed object 540 are shown with dashed boxes to indicate failure status propagation from conversation managed object 540 to other managed objects affected by the event.

To resolve the problem with conversation 416, manager 102 reviews the status and cause of the event received through the notification. Manager 102 then inspects the notifications, the status values, and the time stamps to determine the notification that caused the status change. Once the source of the status change is determined, manager 102 determines whether it can fix the problem. If the problem cannot be solved without the assistance of a human administrator, manager 102 notifies the administrator of the problem. Once the problem is solved, manager 102 returns status values to normal in managed object interfaces 508, 512, 520, 528, 536, 544.

Any type of IT resource can be configured with managed object 108 (FIG. 2), managed object interfaces 112 (FIG. 2), as well as one or more extended interfaces 302, (FIG. 3A) to allow manager 102 to access management features for the underlying resource(s). While the managed object interfaces 112 provide access to a common set of management features that are selectively available for any type of resource based on the access rights of manager 102, the extended interfaces 302 can be implemented to provide manager 102 with selective access to any additional management features available for the resource. Further, managed objects 108 can provide a common framework for managing resources both internal and external to an enterprise, and across domains 104, 106 (FIG. 1).

The logic modules, processing systems, and circuitry described herein may be implemented using any suitable combination of hardware, software, and/or firmware, such as Field Programmable Gate Arrays (FPGAs), Application Specific Integrated Circuit (ASICs), or other suitable devices. The logic modules can be independently implemented or included in one of the other system components. Similarly, other components have been discussed as separate and discrete components. These components may, however, be combined to form larger or different software modules, integrated circuits or electrical assemblies, if desired.

While the invention has been described with reference to various embodiments, it will be understood that these embodiments are illustrative and that the scope of the invention is not limited to them. Many variations, modifications, additions and improvements of the embodiments described are possible. For example, those having ordinary skill in the art will readily implement the steps necessary to provide the structures and methods disclosed herein, and will understand that the components and their arrangement are given by way of example only. The configurations can be varied to achieve the desired structure as well as modifications, which are within the scope of the invention. Variations and modifications of the embodiments disclosed herein may be made based on the description set forth herein, without departing from the scope of the invention as set forth in the following claims.

In the claims, unless otherwise indicated the article “a” is to refer to “one or more than one”.

We claim:

1. A system for managing an information technology (IT) resource, comprising:
a computer processor; and
a managed object executable on the computer processor, wherein:
the managed object represents the resource and includes information regarding at least one interface configured to allow a manager to manage the resource; and
the at least one interface is configured to provide information regarding a relationship between the managed object and another managed object.

2. The system of claim 1, wherein the at least one interface includes attributes that represent information about the resource.

3. The system of claim 1, wherein the at least one interface includes operations to support the management of the resource.

4. The system of claim 1, wherein the at least one interface is configured to provide event notifications to the manager.

5. The system of claim 1, wherein the at least one interface is implemented within the managed object.

6. The system of claim 1, wherein the at least one interface is implemented external to the managed object.

7. The system of claim 1, wherein the at least one interface includes information pertaining to at least one category of management capabilities.

8. The system of claim 1, wherein the at least one interface is configured to provide information that points to an interface description for the managed object, and the interface description exposes only selected management capabilities to the manager.

9. The system of claim 8, wherein the interface description is a Web Services Description Language (WSDL) document, and further comprising:
an extended interface that provides additional management features for the resource to the manager; and
an extended interface description, wherein the extended interface description includes an additional port type that corresponds to the extended interface.

10. The system of claim 1, wherein the at least one interface is configured to provide fault information for the managed object.

11. The system of claim 1, wherein the at least one interface is configured to provide information regarding changes in relationships between the managed object and other managed objects.

12. The system of claim 1, wherein the at least one interface is configured to provide information regarding the operational status of the resource.

13. The system of claim 1, wherein the at least one interface is configured to provide information regarding the configuration of the managed object.

14. The system of claim 1, wherein the at least one interface is configured to provide relation attributes of the managed object.

15. The system of claim 1, wherein the at least one interface is configured to provide a list of relationships that are active for the managed object.

16. The system of claim 1, wherein the at least one interface is configured to provide information regarding other managed objects that have a specific relation with the managed object.

17. The system of claim 1, wherein the at least one interface is configured to allow the manager to control the resource when the manager has the required privileges.

18. The system of claim 1, wherein the at least one interface is configured to query the value of an attribute from members of a collection of managed objects.

19. The system of claim 1, wherein the at least one interface is configured to allow the value of an attribute of a collection of managed objects to be modified.

20. The system of claim 1, wherein the at least one interface is configured to invoke an operation on members of a collection of managed objects.

21. The system of claim 1, wherein information is exchanged between the managed object and the manager via Simplified Object Access Protocol (SOAP).

22. The system of claim 1, further comprising at least one extended interface to provide additional management capability to the manager.

23. The system of claim 1, further comprising a remote procedure call (RPC) handler configured to communicate messages to and from the managed object.

24. The system of claim 1, further comprising a Java application program interface for XML-based remote procedure calls (JVX-RPC) configured to communicate messages to and from the managed object.

25. A computer program product comprising:
an interface;
an extended interface; and
a managed object associated with the interface, wherein the interface includes information indicating relationships between the managed object and other managed objects.

26. The computer program product of claim 25, wherein the at least one interface includes attributes that represent information about the resource and operations to support management of the resource.

27. The computer program product of claim 25, wherein the managed object is configured to exchange information with the manager via SOAP.

28. The computer program product of claim 25, wherein the at least one interface includes events representing state changes that can be reported by the managed object to the manager.

29. The computer program product of claim 25, wherein the at least one interface is configured to allow the manager to subscribe to receive notifications of events.

30. The computer program product of claim 25, wherein the interface is configured to provide at least one of the group of:
information regarding a relationship between the managed object and another managed object;
fault information for the managed object; and
information regarding the operational status of the resource.

31. The computer program product of claim 25, wherein the interface is configured to provide information regarding the configuration of the managed object.

32. The computer program product of claim 25, wherein the interface is configured to provide information regarding other managed objects that have a specific relation with the managed object.

33. The computer program product of claim 25, wherein the interface is configured to allow the manager to control the resource when the manager has the required privileges.

34. The computer program product of claim 25, wherein the interface is configured to query the value of an attribute from members of a collection of managed objects.

35. The computer program product of claim 25, wherein the interface is configured to allow the value of an attribute of a collection of managed objects to be modified.

36. The computer program product of claim 25, wherein the interface is configured to invoke an operation on members of a collection of managed objects.

37. The computer program product of claim 25, further comprising a remote procedure call (RPC) handler configured to communicate messages to and from the managed object.

38. A method for managing an IT resource, comprising:
creating a managed object representing the resource, wherein the managed object includes a management interface;
exposing selected management capabilities for the resource via a description of the management interface; and
allowing a manager to subscribe with the managed object to receive notification of selected events regarding the resource.

39. The method of claim 38 further comprising:
providing information regarding the resource via the management interface including:
relationships between the managed object and other managed objects; and
the configuration of the resource.

40. The method of claim 38 further comprising:
associating a second managed object with the extended interface; and
providing additional information regarding the resource via a document describing selected management features in an extended interface to the manager.

41. The method of claim 38 further comprising:
discovering a document describing the management interface; and
discovering a document describing an extended interface.

42. The method of claim 38, wherein the documents are formatted according to a WSDL.

43. An apparatus for managing an IT resource, comprising:
interface means for representing management capabilities for the resource;
interface means for providing information regarding the relationship between the resource and other resource;
description means for exposing selected management capabilities for the resource to a manager; and
means for sending notification of selected events regarding the resource to the manager.

44. The apparatus of claim 43 further comprising:
means for associating a second interface means with the resource; and
means for providing additional management information regarding the resource to the manager via a second description means.

45. The apparatus of claim 44 further comprising:
means for discovering a document describing the interface means; and
means for discovering a document describing the second interface means.

46. The apparatus of claim 45, wherein the documents are formatted according to WSDL.
